(19) United States
(12) Patent Application Publication
(10) Pub. No.: US 2025/0156962 A1
(43) Pub. Date: May 15, 2025

(54) USER COHORT CREATION BASED ON INTERACTIVITY AND PROFILE OF USERS

(71) Applicant: Honda Motor Co., Ltd., Tokyo (JP)

(72) Inventors: MANUEL DIETRICH, FRANKFURT (DE); THOMAS WEISSWANGE, OFFENBACH (DE); HIFZA JAVED, SAN JOSE, CA (US); NAWID JAMALI, SAN FRANCISCO, CA (US)

(21) Appl. No.: 18/438,216

(22) Filed: Feb. 9, 2024

Related U.S. Application Data
(60) Provisional application No. 63/598,238, filed on Nov. 13, 2023.

(51) Int. Cl. G06Q 50/00

(52) U.S. Cl. CPC G06Q 50/01

(57) ABSTRACT

An electronic device and a method is provided for implementation for user cohort creation based on interactivity and profile of users. The electronic device receives sensor information from a set of sensors associated with a location including a set of users corresponding to a plurality of groups. The electronic device further determines interactivity information associated with each group of the plurality of groups. The electronic device further receives a set of user profiles associated with the set of users. Based on the determined interactivity information and the received set of user profiles, the electronic device creates a set of cohorts from the plurality of groups. Furthermore, the electronic device controls a set of actuators associated with the location to transform a disposition of the set of users from the plurality of groups to the set of cohorts.

### CROSS-REFERENCE TO RELATED APPLICATIONS/INCORPORATION BY REFERENCE

This Application also makes reference to U.S. Provisional Application Ser. No. 63/598,238, which was filed on Nov. 13, 2023. The above stated Patent Application is hereby incorporated herein by reference in their entirety.

### BACKGROUND

In today's world, informal and social gatherings have become an integral part of private and professional networking. Such gatherings may include parties, receptions, lunches, or dinners. Informal gatherings may be distinguished from formal meetings as formal meetings may include an agenda with time slots and specified roles (such as speaker, moderators, and audiences). Further, informal gatherings may have a free conversation flow, dynamic matchmaking, and grouping in different sizes and shapes. However, informal gatherings may end up in unfavorable situations for some individuals, where the individual might get frustrated and uninterested in the ongoing gathering. Typically, any gathering has group of people with dissimilar interest areas sitting together, thus the conversation flow between people of such groups might be negligible. Furthermore, as the event moves forward, such groups of people may interact less and the people of such a group would want to switch groups to be entertained and enjoy the gathering.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device for implementation for user cohort creation based on interactivity and profile of users. The electronic device may include circuitry that may be configured to receive sensor information from a set of sensors associated with a location including a set of users corresponding to a plurality of groups. The circuitry may be further configured to determine interactivity information associated with each group of the plurality of groups. The circuitry may be further configured to receive a set of user profiles associated with the set of users. Based on the determined interactivity information and the received set of user profiles, the circuitry may be further configured to create a set of cohorts from the plurality of groups. Furthermore, the circuitry may be further configured to control a set of actuators associated with the location to transform a disposition of the set of users from the plurality of groups to the set of cohorts.

According to another embodiment of the disclosure, a method for implementation for user cohort creation based on interactivity and profile of users. The method may include reception of sensor information from a set of sensors associated with a location including a set of users corresponding to a plurality of groups. The method may further include determination of interactivity information associated with each group of the plurality of groups. The method may further include reception of a set of user profiles associated with the set of users. The method may further include creation a set of cohorts from the plurality of groups, based on the determined interactivity information and the received set of user profiles. Furthermore, the method may further include controlling a set of actuators associated with the location to transform a disposition of the set of users from the plurality of groups to the set of cohorts.

According to another embodiment of the disclosure, a non-transitory computer-readable medium is provided. The non-transitory computer-readable medium may have stored thereon computer implemented instructions that, when executed by an electronic device, causes the electronic device to execute operations. The operations may implement user cohort creation based on interactivity and profile of users. The operations may include reception of sensor information from a set of sensors associated with a location including a set of users corresponding to a plurality of groups. The operations may further include determination of interactivity information associated with each group of the plurality of groups. The operations may further include reception of a set of user profiles associated with the set of users. The operations may further include creation a set of cohorts from the plurality of groups, based on the determined interactivity information and the received set of user profiles. Furthermore, the operations may further include controlling a set of actuators associated with the location to transform a disposition of the set of users from the plurality of groups to the set of cohorts.

### BRIEF DESCRIPTION OF THE DRAWINGS

FIG. 1 is a block diagram that illustrates an exemplary network environment for user cohort creation based on interactivity and profile of users, in accordance with an embodiment of the disclosure.

FIG. 2 is a block diagram that illustrates an exemplary scenario for user cohort creation based on interactivity and profile of users, in accordance with an embodiment of the disclosure.

FIG. 3 is a block diagram that illustrates an exemplary electronic device of FIG. 1, in accordance with an embodiment of the disclosure.

FIG. 4 is a diagram that illustrates an exemplary processing pipeline for user cohort creation based on interactivity and user profiles, in accordance with an embodiment of the disclosure.

FIG. 5 is a diagram that illustrates an exemplary scenario for transformation of dispositioning of a set of users from a plurality of groups to a set of cohorts, in accordance with an embodiment of the disclosure.

FIG. 6 is a diagram that illustrates an exemplary scenario for transformation of dispositioning of the set of users from the plurality of groups to the set of cohorts, in accordance with an embodiment of the disclosure.

FIG. 7 is a diagram that illustrates an exemplary scenario for enhancement of interaction between users in a group or cohort, in accordance with an embodiment of the disclosure.

FIG. 8 is a flowchart that illustrates operations of an exemplary method for user cohort creation based on interactivity and profile of users, in accordance with an embodiment of the disclosure.

### DETAILED DESCRIPTION

The following described implementation may be found in an electronic device and method for user cohort creation based on interactivity and profile of users. Exemplary aspects of the disclosure may provide an electronic device that may receive sensor information from a set of sensors associated with a location including a set of users corresponding to a plurality of groups. Next, the electronic device may determine interactivity information associated with each group of the plurality of groups, based on the received sensor information. Further, the electronic device may receive a set of user profiles associated with the set of users. Based on the determined interactivity information and the received set of user profiles, the electronic device may create a set of cohorts from the plurality of groups. Furthermore, the electronic device may control a set of actuators associated with the location to transform a disposition of the set of users from the plurality of groups to the set of cohorts. The electronic device of the present disclosure may provide analysis of informal and social gatherings of people based on sensor information. The analysis of the informal/social gatherings of people may determine interactivity between various individuals (also referred herein as users) of a group in the informal/social gathering. The interactivity of the individual users may be determined by application of various machine learning (ML) models on the sensor information. Further, the electronic device may receive user profiles of the users present in the informal/social gathering. Based on the interactivity of the users and the user profiles, the electronic device may create a new group of users with similar interests or characteristics. Such new groups are referred herein as cohorts. Furthermore, the electronic device may control plurality of actuators, such as a robot, a robotic chair, a table, and/or a scheduler, that may guide or recommend and/or enable the users to switch from a present position of the groups to a new position associated with a set of cohorts. Therefore, the disclosed electronic device may be incorporated in applications such as audio/video devices, robots and/or wearable devices, to analyze the groups of the social gathering with lower interactivity and provide a set of cohorts to a set of actuators to transform the dispositioning of the set of users from the groups to the set of cohorts.

The dynamic re-arrangement of users may increase an interactivity level of the users as the new groups (or cohorts) may be formed based on a degree of similarity of user profiles of the users and also the interactivity information of the users in previous groups. Thus, the users may experience increased interest in the social gathering based on the dynamic re-arrangement of the users in the cohorts. Also, the sensor information associated with the users may be collected at regular intervals and the interactivity information of the cohorts of the users may also be determined accordingly. Thus, in case a decline in an interactivity level is detected in a certain cohort of users, then the users of such a cohort may be distributed into other cohorts based on user profiles of the users. Hence, an overall interactivity and liveliness of the social gathering may be increased and maintained throughout the event, such that the attendees do not feel disinterested in the event.

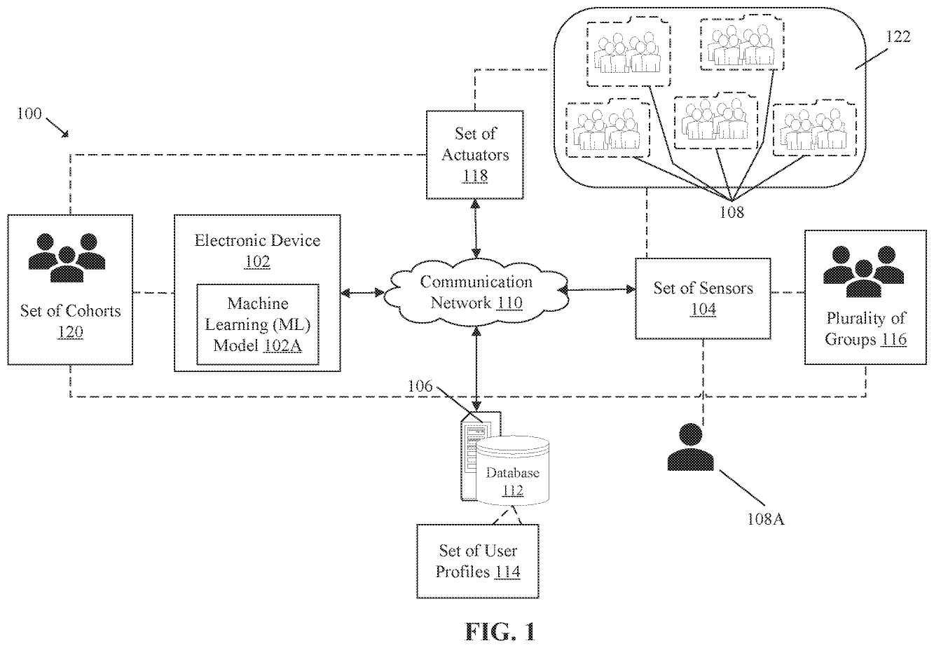

FIG. 1 is a block diagram that illustrates an exemplary network environment for user cohort creation based on interactivity and profile of users, in accordance with an embodiment of the disclosure. With reference to FIG. 1, there is shown a network environment 100. The network environment 100 may include an electronic device 102, a server 106, a database 112, and a communication network 110. The electronic device 102 may be associated to a set of actuators 118. Further, a set of sensors 104 may be associated with the electronic device 102. In FIG. 1, there is further shown a set of user profiles 114 that may be stored in the database 112. In addition, the electronic device 102 may include a machine learning (ML) model 102A. There is further shown a user 108A, who may be associated with a location 122 and who may operate or be associated with the electronic device 102. Also, the set of sensors 104 and the set of actuators 118 may be associated with the location 122 and a set of users 108 (as shown in FIG. 1). The set of users 108 may correspond to a plurality of groups 116. The plurality of groups 116 are hereinafter interchangeably referred as a set of groups 116. In FIG. 1, there is also shown, a set of cohorts 120.

The electronic device 102 may include suitable logic, circuitry, interfaces, and/or code that may be configured to receive sensor information from the set of sensors 104 associated with a location (such as the location 122) including the set of users 108 corresponding to the plurality of groups 116. The electronic device 102 may determine interactivity information associated with each group of the plurality of groups 116, based on the received sensor information. The electronic device 102 may receive a set of user profiles (such as the set of user profiles 114) associated with the set of users 108. The electronic device 102 may create the set of cohorts 120 from the plurality of groups 116, based on the determined interactivity information and the received set of user profiles 114. The electronic device 102 may control the set of actuators 118 associated with the location 122 to transform a disposition of the set of users 108 from the plurality of groups to the set of cohorts 120. Examples of the electronic device 102 may include, but are not limited to, a computing device, a smartphone, a cellular phone, a mobile phone, a gaming device, a mainframe machine, a server, a computer workstation, a machine learning device (enabled with or hosting, for example, a computing resource, a memory resource, and a networking resource), a wearable device and/or a consumer electronic (CE) device.

In an embodiment, the ML model 102A may be trained to identify a relationship between inputs, such as features in a training dataset, and output labels, such as the determining the interactivity information and creating the set of cohorts using a set of user profiles of the set of users. The ML model 102A may be defined by its hyper-parameters, for example, number of weights, cost function, input size, number of layers, and the like. The parameters of the ML model 102A may be tuned and weights may be updated so as to move towards a global minima of a cost function for the ML model 102A. After several epochs of the training on the feature information in the training dataset, the ML model 102A may be trained to output interactivity information and/or the creation of the set of cohorts 120.

The ML model 102A may include electronic data, which may be implemented as, for example, a software component of an application executable on the electronic device 102. The ML model 102A may rely on libraries, external scripts, or other logic/instructions for execution by a processing device. The ML model 102A may include code and routines configured to enable a computing device, such as the electronic device 102 to perform one or more operations, such as the determination of the interactivity information and/or the creation of the set of cohorts 120. Additionally or alternatively, the ML model 102A may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 102A may be implemented using a combination of hardware and software. Examples of the ML model 102A may include, but is not limited to, Linear regression, Decision trees, Logistic regression, Naïve Bayes, Random Forest, Support Vector Machine, K-Nearest Neighborhood, Neural Networks, Dimensionality Reduction, Classification, Clustering, Gradient Boosting, Deep Learning, and Reinforcement Learning.

In an embodiment, the machine learning (ML) model 102A may be a computational network or a system of artificial neurons, arranged in a plurality of layers, as nodes that may be configured to determine the interactivity information from the received sensor information. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the ML model 102A may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different mathematical function.

In training of the ML model 102A, one or more parameters of each node of the neural network may be updated based on whether an output of the final layer for a given input (from the training dataset) matches a correct result based on a loss function for the neural network. The above process may be repeated for same or a different input until a minima of loss function may be achieved and a training error may be minimized. Several methods for training are known in art, for example, gradient descent, stochastic gradient descent, batch gradient descent, gradient boost, meta-heuristics, and the like. The neural network model may rely on libraries, external scripts, or other logic/instructions for execution by a processing device. The neural network model may include code and routines configured to enable a computing device to perform one or more operations, such as the determination of the interactivity information and/or the creation of the set of cohorts 120. Additionally or alternatively, the neural network model may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

The set of sensors 104 may include suitable logic, circuitry, and interfaces that may be configured to capture sensor information at the location 122 including the set of users 108 corresponding to the plurality of groups 116. In an embodiment, the set of sensors 104 may be at least one of an infrared sensor, a radio frequency sensor, a proximity sensor, a photoelectric sensor, a touch sensors, a photodetector, a camera, an audio-input device, a pressure sensor, a thermistor, a position sensor, a temperature sensor, a humidity sensor, a strain sensor, or a weight sensors. In an embodiment, the set of sensors 104 may be associated with the location 122 and may also be associated with the set of users 108. For example, one or more sensors of the set of sensors 104 may be installed on and/or placed on objects associated with the location 122. In an example, the objects may include a ceiling or a roof, a floor, walls, or electronic devices associated with the location 122, such as a room, a hall, an indoor setting, or an outdoor venue. In certain cases, one or more sensors of the set of sensors 104 may also be worn or carried by the set of users 108 as wearable sensor devices, such as smart watches, smart-bands; or other electronic devices, such as smart phones, laptops, or tablet computers. In an example, a user's pulse or heart rate may be measured by a wearable device (such as a smart watch) and the measured pulse or heart rate may be used to determine a degree of interactivity of the user (such as the user 108A).

The set of sensors 104 may be the camera sensor. For example, the camera may capture an image of the set of users 108 corresponding to the plurality of groups 116. Further, the electronic device 102 may apply the ML model 102A on the captured image. The ML model 102A may determine the interactivity information associated with the set of users 108. For example, the set of sensors 104 may include a set of cameras that may capture images including facial expressions of users in a group of the plurality of groups 116. Based on the application of the ML model 102A on the captured images, a degree of interactivity of each user may be determined. In an example, the ML model 102A may correspond to a neural network model (such as a convolution neural network model or other deep learning models), which may analyze the facial expressions in each captured image and determine a level of interactivity of the users based on the analysis. In an embodiment, the set of sensors 104 may be the infrared sensor. For example, the infrared sensor may determine a behavior of the user 108A. Further, information related to the behavior of the user 108A may be transmitted to the electronic device 102 as the sensor information. Further, the electronic device 102 may apply the ML model 102A on the received sensor information including the information related to behavior to determine an interactivity level of the user 108A.

The server 106 may include suitable logic, circuitry, and interfaces, and/or code that may be configured to receive the sensor information from the set of sensors 104. The server 106 may determine the interactivity information associated with the plurality of groups 116, from the received sensor information. The server 106 may receive the set of user profiles 114 associated with the set of users 108. The server 106 may create a set of cohorts from the plurality of the groups 116, based on the determined interactivity information. The server 106 may control the set of actuators 118 associated with the location 122 to transform the disposition of the set of users 108 from the plurality of groups 116 to the set of cohorts 120.

The server 106 may be implemented as a cloud server and may execute operations through web applications, cloud applications, HTTP requests, repository operations, file transfer, and the like. Other example implementations of the server 106 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and the electronic device 102, as two separate entities. In certain embodiments, the functionalities of the server 106 can be incorporated in its entirety or at least partially in the electronic device 102 without a departure from the scope of the disclosure. In certain embodiments, the server 106 may host the database 112. Alternatively, the server 106 may be separate from the database 112 and may be communicatively coupled to the database 112.

The set of users 108 may correspond to a cluster of users (such as the user 108A) at a location, such as the location 122. Further, the user 108A from the set of users 108 may be a participant of the informal/social gathering associated with the location 122. Furthermore, the user 108A may be associated with at least one user profile from the set of user profiles 114.

The database 112 may include suitable logic, interfaces, and/or code that may be configured to store the set of user profiles 114. The database 112 may be derived from data off a relational or non-relational database, or a set of comma-separated values (csv) files in conventional or big-data storage. The database 112 may be stored or cached on a device, such as a server (e.g., the server 106) or the electronic device 102. The device storing the database 112 may be configured to receive a query for the user profiles from the electronic device 102 or the server 106. In response, the device of the database 112 may be configured to retrieve and provide the queried user profiles to the electronic device 102 or the server 106, based on the received query. In some embodiments, the database 112 may be hosted on a plurality of servers stored at the same or different locations. The operations of the database 112 may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

The set of user profiles 114 may include the user profiles associated with each user 108A of the set of users 108. Each user profile of the set of user profiles 114 may include at least one of an area of interest of a user, demographic information of the user, beliefs of the user, aversions of the user, or skills of the user. Further, the demographic information may include one or more age, identity, address, origin, family details and the like, associated with one or more users such as the user 108A. The set of user profile 114 may be used to determine the cohorts from the plurality of users 108 associated with the plurality of groups 116. The user profile 114 of the user may be received by the electronic device 102 to apply the ML model 102A for creating the set of cohorts 120 and controlling the set of actuators 118 to transform the disposition of the set of users 108 from the plurality of groups 116 to the set of cohorts 120.

The communication network 110 may include a communication medium through which the electronic device 102 and the server 106 may communicate with one another. The communication network 110 may be one of a wired connection or a wireless connection. Examples of the communication network 110 may include, but are not limited to, the Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The plurality of groups 116 may correspond to a pre-configured set of users 108. For example, groups 116 may include the set of users 108 belonging from different age group, different interest areas, different skills, different demographic information, and/or different belief systems. Further, the pre-configured set of users 108 may or may not belong to the group with shared area of interest or demographic information. Thus, the group 116 may have a lower level of interaction. The plurality of groups 116 are hereinafter interchangeably referred as the set of groups 116.

The set of actuators 118 may include suitable logic, circuitry, interfaces, and/or code that may be configured to be controlled by the electronic device 102 to transform the disposition of the set of users 108 from the plurality of groups 116 to the set of cohorts 120. The actuators 118 may be situated at the location 122. Examples of the actuators 118 may include, but are not limited to, a furniture object, such as a chair, a table; a smart device, such as a robot; an audio-output device; or a scheduler, associated with the location 122.

In an embodiment, the set of actuators 118 may be a part of an electronic device 102 that may help the electronic device 102 to physically move based on a conversion of electric energy into a mechanical force. For example, the set of actuators 118 may correspond to the chair, where the chair may be a robotic chair. The chair may receive control instructions from the electronic device 102 to transform the disposition of the set of users 108 from the plurality of groups 116 to the set of cohorts 120. The chair may be configured to move from a first position associated with the plurality of groups to a second position associated with the set of cohorts 120. In an embodiment, the set of actuators 118 may correspond to the table, where the table may be a robotic table. Further, the table may receive control instructions to transform the disposition of the set of users from the plurality of groups 116 to the set of cohorts 120. Further, the table may be configured to move from a first position associated with the plurality of groups to a second position associated with the set of cohorts 120. In an embodiment, the set of actuators 118 may correspond to the robot. Further, the robot may receive control instructions to render at least one of media content, a recommendation, or an interactive chat to the set of users 108. Further, the robot may be configured to transform the disposition of the set of users from the plurality of groups 116 to the set of cohorts 120.

In an embodiment, the set of actuators 118 may correspond to the audio-output device. Further, the audio-output device may receive control instructions to render at least one audio content or background noises to the set of users 108. Further, the audio-output device may be configured to transform the disposition of the set of users 108 from the plurality of groups 116 to the set of cohorts 120. In an embodiment, the set of actuators 118 may correspond to the scheduler. Further, the scheduler may receive control instructions to determine a schedule for an activity associated with the set of users 108 at the location 122, based on the set of cohorts 120. Further, the scheduler activity may correspond to at least one of, but not limited to, a serving of a course of a meal, a speech, or a game.

Each cohort of the set of cohorts 120 may correspond to users with shared areas of interest or similar demographic information. For example, cohorts may include, but are not limited to, users of similar age groups, interest areas, beliefs, aversions, and skills. The cohorts may have a higher level of interactivity.

The location 122 may correspond to a place (which may be indoors, such as a room or a hall; or outdoors, such as a garden or an open-air setup) that includes the set of users 108 corresponding to the plurality of groups 116. Further, the location 122 may be include the set of sensors 104 and the set of actuators 118. For example, the location 122 may include the set of users 108 who may be participants of a party, a social gathering, an informal meeting, a get-together, or a function.

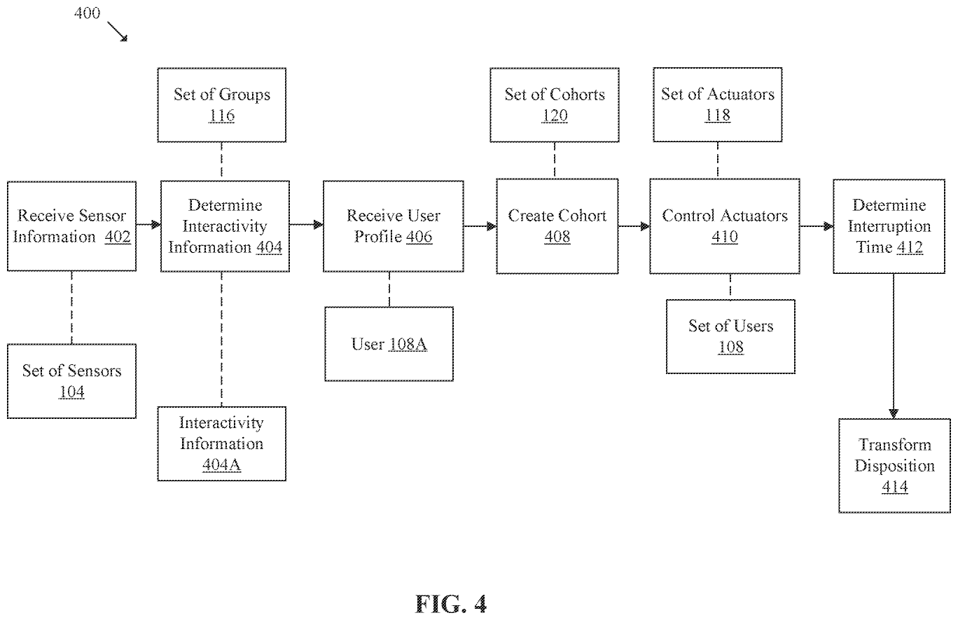

In operation, the electronic device 102 may be configured to receive the sensor information associated with the set of users 108 corresponding to the plurality of groups 116. The sensor information may include information from the set of sensors 104 such as an infrared sensor, a radio frequency sensor, a proximity sensor, a photoelectric sensor, a touch sensor, a photodetector, a camera, an audio-input device, a pressure sensor, a thermistor, a position sensor, a temperature sensor, a humidity sensor, a strain sensor, or a weight sensors. Herein, the sensor information may provide information associated with the spontaneous electrical activity of the user 108A from the plurality of the groups 116. Thus, the sensor information may be stored on the database 112 for further processing. Alternatively, the sensor information may be stored locally on a memory of the electronic device 102. Details related to reception of the sensor information are further described, for example, in FIG. 4 (at 402).

The electronic device 102 may determine the interactivity information associated with each group of the plurality of groups 116, based on the received sensor information. It may be appropriate that the interactivity information may be indicative of the high interactivity or low interactivity between the set of users 108 from the plurality of the groups 116. For example, users who engage in a conversation for a certain predetermined time may have a higher interactivity level than other users who may not speak with one another. Also, users who may maintain eye contact or respond to a speaker may have a higher level of interactivity than the users who avoid eye contact or do not respond to the speaker. Details related to the determination of the interactivity information are further described, for example, in FIG. 4 (at 404).

The electronic device 102 may be configured to receive the set of user profiles 114 associated with the set of users 108. It may be noted that in certain scenarios, user profiles of users having an interactivity level lower than a threshold may only be received, while user profiles of other users having an interactivity level higher than the threshold may not be received. In another scenario, user profiles of all users, irrespective of the interactivity level of the users, may be received. Details related to the reception of the set of user profiles 114 are further described, for example, in FIG. 4 (at 406).

The electronic device 102 may be configured to create the set of cohorts 120. The set of cohorts 120 may be created from the set of users 108 associated with the plurality of groups 116. The set of cohorts 120 may be created based on the determined interactivity information and the received set of user profile 114. Details related to the creation of the set of cohorts 120 are further described, for example, in FIG. 4 (at 408).

The electronic device 102 may be configured to control the set of actuators 118. The set of actuators 118 may be associated with the location 122. The actuators 118 may be controlled to transform the disposition of the set of users 108 from the plurality of groups 116 to the set of cohorts 120. Herein, the transformation of the disposition of the set of users 108 from the plurality of groups 116 to the set of cohorts 120 may induce interactivity between the set of users 108. Users in the set of cohorts 120 may be more interactive with one another than users in the plurality of groups 116. Hence, an overall interactivity of the set of users 108 may be increased based on the transformation of the disposition of the set of users 108 from the plurality of groups 116 to the set of cohorts 120. For example, the set of users 108 may be seated in a pre-configured group. The pre-configured group may not be suited to the set of users 108 and the set of users 108 may not have common topics to interact upon. The disclosed electronic device 102 may thereby enable a robust and efficient creation of the set of cohorts 120 based on the determined interactivity information and the received set of user profile 114 by control of the set of actuators 118 for dispositioning of the set of users 108 from the plurality of groups 116 to the set of cohorts 120. The disclosed electronic device 102 may be incorporated in applications such as audio/video devices, robots, and/or wearable devices, to analyze the groups of the social gathering with lower interactivity and provide the set of cohorts 120 based on control of the set of actuators 118 to transform the dispositioning of the set of users 108 from the groups 116 to the set of cohorts 120.

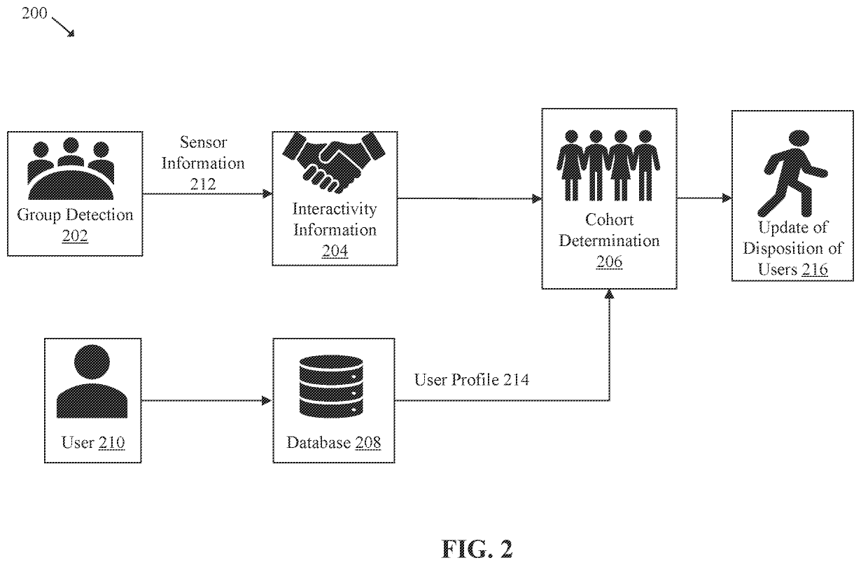

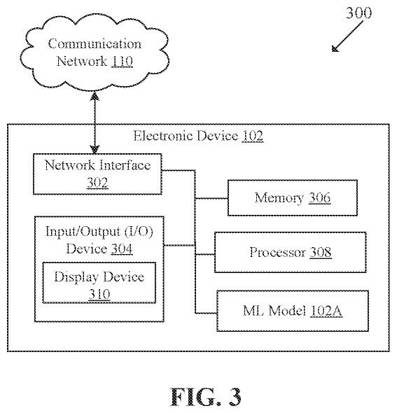

FIG. 2 is a block diagram that illustrates an exemplary scenario for user cohort creation based on interactivity and profile of users, in accordance with an embodiment of the disclosure. FIG. 2 is explained in conjunction with elements from FIG. 1. With reference to FIG. 2, there is shown an exemplary scenario 200 for implementation of user cohort creation based on interactivity and user profiles. The scenario 200 may include exemplary set of operations 202, 206, and 216 that may be executed by any computing system, for example, by the electronic device 102 of FIG. 1 or by a processor 308 of FIG. 3. The scenario 200 may also include interactivity information 204, sensor information 212, a user 210, a database 208, and a user profile 214 of the user 210. The set of operations of the scenario 200 are described herein next.

At 202, the plurality of groups 116 may be detected. In an embodiment, the electronic device 102 may be configured to detect the plurality of groups 116 of the set of users 108. The plurality of groups 116 are hereinafter interchangeably referred as the set of groups 116. The electronic device 102 may receive the sensor information 212 from the set of sensors 104 associated with the location 122. Further, the electronic device 102 may apply the ML model 102A on the received sensor information 212 to detect the plurality of groups 116. For example, the sensor information 212 may include an image or a video captured by the set of sensors 104 (such as a set of cameras). Further, the electronic device 102 may be configured to apply the ML model 102A on the image or the video to determine each group of the plurality of groups 116 associated with the location 122.

In an embodiment, the electronic device 102 may be configured to determine on-going conversations between two or more users by application of the ML model 102A on the sensor information 212 received from the set of sensors 104 (such as audio-input devices and/or cameras). For example, the electronic device 102 may be configured to apply speech processing to audio input from each user from the set of users 108 associated with the plurality of group 116. Further, the electronic device 102 may be configured to apply the image processing to the images or the videos captured from the set of users 108 to analyze the detect gaze, determine facial expressions, and determine facial orientation of the set of users 108. Further, the electronic device 102 may be configured to apply the ML model 102A to the output of the speech processing and the image processing to determine information about the ongoing conversations associated with each group of the plurality of groups 116. For example, the electronic device 102 may identify which individuals from the users of a group are conversing and which other individuals are silent in the group. Furthermore, electronic device 102 may be configured determine the plurality of groups 116, based on the determined ongoing conversations between the set of users 108.

At 204, the interactivity information 204 may be determined. In an embodiment, the electronic device 102 may be configured to determine the interactivity information 204 associated with each group of the plurality of groups 116 based on the sensor information 212 from the set of sensors 104. The interactivity information 204 may be associated with the quality of interaction or conversations (such as low interactivity or high interactivity) between the set of users 108 associated with the plurality of groups 116. The interactivity information 204 may correspond to a measurement of at least one of, but not limited to, a conversational involvement, a balance of contribution, or an individual and/or group affect.

In an embodiment, the sensor information 212 may be used to measure the conversational involvement of the set of users 108. The measurement of the conversational involvement may be performed based on audio/video processing and/or a trained deep neural network. In an embodiment, the balance of contribution of a user may correspond to a percentage of total time of a conversation in which the particular user has spoken. In an example, the sensor information 212 may include information such as a length of a time interval in which each user speaks and a length of a total time interval in which speech of the set of users 108 was monitored. The balance of contribution may be determined based on such information included in the sensor information 212. The various other effects may be associated to evaluation of the involvement of each of the user 108A from the set of the users 108 associated with the plurality of groups 116. For example, the various effects may include a direct facial orientation, a direct body orientation, an eye gaze, a closer proximity (such as leaning forward or backward), positive reinforcements (such as head nods and smiles), gesture frequencies, facial or vocal expressions, silence, response latency, physical behavior, vocal warmth, interest, involvement, friendliness, and the like. In an embodiment, the sensor information 212 may be used to measure individual or group affect, based on the various effects mentioned in the aforementioned. For example, the individual or group affect may be measured based on a facial expression, a skin temperature, and the like.

At 206, the set of cohorts 120 may be determined. In an embodiment, the electronic device 102 may be configured to determine the set of cohorts 120. The set of cohorts 120 may be determined based on the interactivity information 204 and common interest areas of the set of users 108 associated with the plurality of groups 116. The common interest areas of the set of users 108 (for example, the user 108A or the user 210) may be determined from the set of user profiles (such as the user profiles 214) received from the database 208 and/or a memory of the electronic device 102.

In an embodiment, the set of cohorts 120 may be determined based on the shared interest of each of the users from the set of the users associated with the plurality of groups 116. For example, a first cohort of users may correspond to four users (e.g., users A, B, C, and D) who may be interested in discussion of sports and a second cohort of users may correspond to four users (e.g., users P, Q, R, and S) who may be interested in discussion of the latest gadgets. In an example, initially the eight users may distributed across three groups, such as a Group-1 (with the users A, B, P, and Q), a Group-2 (with the users C and R), and a Group-3 (with the users D and S). The users of each of the three groups may have a low interactivity with one another as the interest areas of the users within each of the groups may not be similar. Based on the interactivity information 204 and the set of user profiles 114, the electronic device 102 may create the first cohort of users (i.e., the users A, B, C, and D) who may be interested in sports and may create the second cohort of users (i.e., the users P, Q, R, and S) who may interested in latest gadgets.

At 216, disposition of users may be updated. The electronic device 102 may be configured to control the set of actuators 118 associated with the location 122 to transform the disposition of the set of users 108 from the plurality of groups 116 to the set of cohorts 120. In an embodiment, the set of actuators 118 may be controlled to move from a first position associated with the plurality of groups 116 to a second position associated with the set of cohorts 120 at an interruption time. In an embodiment, the set of actuators 118 may be controlled to render at least one of media content, a recommendation, audio content, background noises or an interactive chat to the set of users at the interruption time. In another embodiment, the set of actuators 118 may be controlled to determine the schedule for an activity associated with the set of users at the location, based on the set of cohorts 120 at the interruption time. Further, the electronic device 102 may be configured to update the disposition of user 108A.

In an embodiment, the set of actuators 118 may be configured to a set of robots. The electronic device 102 may be configured to control the set of robots to transform the disposition of the set of users 108 from the plurality of groups 116 to the set of cohorts 120. The set of robots may recommend or escort the set of users 108 to transform the disposition of the set of users 108 from a first position associated with the plurality of groups 116 to a second position associated with the set of cohorts 120. Further, the electronic device 102 may be configured to control the set of robots to recommend or induce interactive topic to the set of users 108 associated with the plurality of groups 116 to improve the low interactivity.

FIG. 3 is a block diagram that illustrates an exemplary electronic device of FIG. 1, in accordance with an embodiment of the disclosure. FIG. 3 is explained in conjunction with elements from FIG. 1. With reference to FIG. 3, there is shown the exemplary electronic device 102. The electronic device 102 may include a machine learning (ML) model 102A, a processor 308, a memory 306, an input/output (I/O) device 304, and a network interface 302. The memory 306 may store the user profiles 114 associated with the set of users 108. The input/output (I/O) device 304 may include a display device 310.

The network interface 302 may include suitable logic, circuitry, interfaces, and/or code that may be configured to facilitate communication between the electronic device 102 and the server 106, via the communication network 110. The network interface 302 may be implemented by use of various known technologies to support wired or wireless communication of the electronic device 102 with the communication network 110. The network interface 302 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 302 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The I/O device 304 may include suitable logic, circuitry, interfaces, and/or code that may be configured to receive an input and provide an output based on the received input. For example, the I/O device 304 may receive a user input indicative of a selection of the user profile from the set of user profiles 114. The I/O device 304 may be further configured to display or render the position associated with the selected user 108A from the set of users 108. The I/O device 304 may include the display device 310. Examples of the I/O device 304 may include, but are not limited to, a display (e.g., a touch screen), a keyboard, a mouse, a joystick, a microphone, or a speaker. Examples of the I/O device 304 may further include braille I/O devices, such as braille keyboards and braille readers.

The display device 310 may include suitable logic, circuitry, and interfaces that may be configured to display or render the position associated with the user 108A. The display device 310 may be a touch screen which may enable a user (e.g., the user 108A) to provide a user-input via the display device 310. The touch screen may be at least one of a resistive touch screen, a capacitive touch screen, or a thermal touch screen. The display device 310 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 310 may refer to a display screen of a head mounted device (HMD), a smart-glass device, a see-through display, a projection-based display, an electro-chromic display, or a transparent display.

The memory 306 may include suitable logic, circuitry, interfaces, and/or code that may be configured to store one or more instructions to be executed by the processor 308. The one or more instructions stored in the memory 306 may be configured to execute the different operations of the processor 308 (and/or the electronic device 102). The memory 306 may be further configured to store the set of user profile 114 and the sensor information 212. The memory 306 may further store the interactivity information 204. Examples of implementation of the memory 306 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The processor 308 may include suitable logic, circuitry, and/or interfaces that may be configured to execute program instructions associated with different operations to be executed by the electronic device 102. The operations may include the reception of the sensor information, the determination of the interactivity information, the reception of the set of user profiles, the creation of the set of cohorts, and the control of the set of actuators. The processor 308 may include one or more processing units, which may be implemented as a separate processor. In an embodiment, the one or more processing units may be implemented as an integrated processor or a cluster of processors that perform the functions of the one or more specialized processing units, collectively. The processor 308 may be implemented based on a number of processor technologies known in the art. Examples of implementations of the processor 308 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits. Various operations of the processor 308 for implementation of machine-learning based set of cohorts creation using a set of user profiles and sensor information are described further, for example, in FIG. 4.

FIG. 4 is a diagram that illustrates an exemplary processing pipeline for user cohort creation based on interactivity and user profiles, in accordance with an embodiment of the disclosure. FIG. 4 is explained in conjunction with elements from FIG. 1, FIG. 2 and FIG. 3. With reference to FIG. 4, there is shown an exemplary processing pipeline 300 that illustrates exemplary operations from 402 to 414 for implementation of user cohort creation based on interactivity and user profiles. The exemplary operations 402 to 414 may be executed by any computing system, for example, by the electronic device 102 of FIG. 1 or by the processor 308 of FIG. 3. In FIG. 4, there are further shown the set of sensors 104, the set of groups 116, interactivity information 404A, the user 108A, the set of cohorts 120, the set of actuators 118, and the set of users 108.

At 402, an operation for sensor information reception may be executed. The processor 308 may be configured to receive the sensor information (e.g., the sensor information 212) from the set of sensors 104 associated with the location 122 including the set of users 108 corresponding to the plurality of groups 116. The plurality of groups 116 are hereinafter interchangeably referred as a set of groups 116. The sensor information 212 may be obtained by the sensors 104 based on the user activities by the set of users 108 during a gathering involving the set of users 108. Examples of activities captured in the sensor information, may include, but is not limited to, a gesture, a posture, a speech, a gaze, an action, or a facial orientation, associated with the set of users 108. Further, the set of sensors 104 capturing the user activities, may include, but is not limited to, an infrared sensor, a radio frequency sensor, a proximity sensor, a photoelectric sensor, a touch sensor, a photodetector, a camera, an audio-input device, a pressure sensor, a thermistor, a position sensor, a temperature sensor, a humidity sensor, a strain sensor, and a weight sensor.

In an embodiment, the set of sensors 104 capturing the user activities may correspond to a set of cameras. It may be apparent that the user activities may be determined based on images or a videos captured by the set of cameras. Further, in order to obtain the sensor information from the captured images/videos, the processor 308 of the electronic device 102 may apply the ML model 312 on the captured images/videos to identify the captured activities associated with at least one of a gesture, a posture, a speech, a gaze, an action, or a facial orientation, associated with the set of users 108. In order to determine the users activities, a plurality of cameras may be deployed in the location 122 associated with the set of users 108. For example, one or more cameras may be deployed on a roof/ceiling/walls/floor of a hall, room, or an outdoor venue associated with the location 122. In another example, the one or more cameras may be deployed on objects within the hall, room, or the outdoor venue.

In an embodiment, the set of sensors 104 capturing the user activities may correspond to a set of proximity sensors. It may be apparent that the user activities may be determined based on electrical signals by the proximity sensors. The proximity sensor performs non-contact detection of a nearby object. The proximity sensor may use eddy current generated in an object to be detected by electromagnetic induction, and thus the proximity sensor may be able to capture the changes in the capacity of the electric signals due to the proximity of the object to be detected. Further, in order to obtain the sensor information from the electrical signals, the processor 308 of the electronic device 102 may apply the ML model 312 on the electric signals to identify captured activities associated with at least one of a gesture, a posture, a movement, an action, or a facial orientation, associated with the set of users 108. In order to obtain the users activities, a plurality of proximity sensors may be deployed in the location 122 associated with the set of users 108. For example, one or more proximity sensors may be deployed on a roof/ceiling/walls/floor of a hall, room, or an outdoor venue associated with the location 122. In another example, the one or more proximity sensors may be deployed on objects within the hall, room, or the outdoor venue.

At 404, an operation for interactivity information determination may be executed. The processor 308 may be configured to determine the interactivity information (e.g., the interactivity information 404A) associated with each group of the plurality of groups 116, based on the received sensor information 212. It should be noted that the received sensor information 212 may be associated with the activities of the set of users 108 associated with the location 122. In an embodiment, the electronic device 102 may be configured to apply the ML model 102A on the received sensor information 212 to determine the interactivity information 404A. For example, the ML model 102A may be applied on the sensor information 212 to determine whether an interactivity among users of a group corresponds to a low interactivity or a high interactivity. In an example, if the processor 308 determines (based on the application of the ML model 102A on the sensor information 212) that one or more users of a group are not participating in a conversation (for example, by not speaking), not showing interesting in the conversation by nodding, or providing other neutral facial expressions, the processor 308 may determine that such one or more users of the group have a low interactivity level. On the contrary, if the processor 308 determines that certain users are actively contributing to the conversation, maintaining eye contact, and nodding during the conversation, the processor 308 may determine that such users have a higher interactivity level. In an example, the interactivity information 404A may be associated with at least one of, conversational involvement, balance of contributions, or individual/group affect.

At 406, an operation for user profile reception may be executed. The processor 308 may be configured to receive the set of user profiles 114 associated with the set of users 108 (for example, the user 108A). The set of user profiles 114 may be stored on the database 112. Additionally or alternatively, the set of user profiles 114 may be stored in the memory 306. In an embodiment, the set of user profiles 114 may include data retrieved from an online database, a social network, an explicit user input, an operational system component, and the like. Examples of information in each user profile in the set of user profiles 114 may include, at least one of, but not limited to, an area of interest of a user, demographic information of the user, beliefs of the user, aversions of the user, or skills of the user.

For example, the database 112 may receive information related to the set of user profiles 114 as data retrieved from operational system component. In an example, the operational system component may be configured to analyze an ongoing interaction or communication between the set of users 108 corresponding to the plurality of groups 116. In such a scenario, the data retrieved from the operational system components may be a real time data input used to update the received user profile. Furthermore, the updated user profile may be transmitted to the electronic device 102 for further processing.

At 408, an operation for the set of cohorts creation may be executed. The processor 308 may be configured to create the set of cohorts 120 from the plurality of groups 116, based on the determined interactivity information 204 and the received set of user profiles 114. Further, the set of cohorts 120 may be created based on the computation of shared interests between the set of users 108 from the plurality of the groups 116. In an embodiment, the electronic device 102 may be configured to create the set of cohorts 120 by applying the ML model 102A on the determined interactivity information 204 and the received set of user profile 114.

In an embodiment, the cohorts 120 may be the set of users 108 with certain common characteristics. For example, the set of users 108 with shared interest may be clustered and the set of cohorts 120 may correspond to users with common characteristics, such as, but are not limited to, age groups, interest in games, place of origin, religion, language, or political view. Thus, the cohorts may have a higher level of interactivity.

At 410, an operation for control of actuators may be executed. The processor 308 may be configured to control the set of actuators 118 associated with the location 122 to transform the disposition of the set of users 108 from the plurality of groups 116 to the set of cohorts 120. It may be noted that the set of actuators 118 may correspond to at least one of a chair, a table, a robot, an audio-output device, or a scheduler, associated with the location 122.

In an embodiment, the set of actuators 118 may correspond to one or more chairs. Herein, the chair may be controlled to transform the disposition of the set of users 108 from the plurality of groups 116 to the set of cohorts 120. For example, the processor 308 may control the chair such that the chair is configured to move from a first position associated with the plurality of groups 116 to a second position associated with the set of cohorts 120.

In an embodiment, the set of actuators 118 may correspond to one or more tables. Herein, the table may be controlled to transform the disposition of the set of users 108 from the plurality of groups 116 to the set of cohorts 120. For example, the processor 308 may control the table such that the table may be configured to move from a first position associated with the plurality of groups 116 to a second position associated with the set of cohorts 120.

In an embodiment, the set of actuators 118 may correspond to one or more robots. Herein, the robot may be controlled to render at least one of media content, a recommendation, or an interactive chat to the set of users 108. For example, the processor 308 may control the robot such that the robot may be configured to transform the disposition of the set of users 108 from the plurality of groups 116 to the set of cohorts 120.

In an embodiment, the set of actuators 118 may correspond to one or more audio-output devices. Herein, the audio-output device may be controlled to render at least one of, audio content or background noises to the set of users 108. For example, the processor 308 may control the audio-output device such that the audio-output device may be configured to transform the disposition of the set of users 108 from the plurality of groups 116 to the set of cohorts 120.

In an embodiment, the set of actuators 118 may correspond to one or more schedulers. Herein, the processor 308 may control the scheduler such that the scheduler may be controlled to determine the schedule for an activity associated with the set of users 108 at the location 122, based on the set of cohorts 120. For example, the activity may correspond to at least one of, but not limited to, a serving of a course of a meal, a speech, or a game.

At 412, an operation for interruption time determination may be executed. The processor 308 may be configured to determine a time for an interruption of an ongoing conversation between users of a group of the plurality of groups 116. The determination of the time for interruption may be based on the received sensor information. The processor 308 may be configured to control the set of actuators 118 to interrupt the ongoing conversation between the users of the group at the determined time.

For example, certain users of the set of users 108 associated with the plurality of groups 116 may have a low interactivity level during an ongoing conversation. The electronic device 102 may create the set of cohorts 120 for the set of users 108 based on the users with the low interactivity. Then, the electronic device 102 may determine the time for interruption of an ongoing conversation between such users with the low interactivity level. Further, the set of users 108 (including the users with the low interactivity level) may be interrupted at the determined time. For example, the determined time may be 10 seconds. Further, the interruption may be associated with the control of the set of actuators 118. Thus, the set of users 108 may be interrupted by any of the actuators from the set of actuators 118 (such as the chair, the table, the robot, the audio-output device or the scheduler) at the end of the 10 seconds.

At 414, an operation for disposition transformation may be executed. The processor 308 may be configured to control the set of actuators 118 to transform the disposition of the set of users 108 from the plurality of groups 116 to the set of cohorts 120. In an embodiment, the set of actuators 118 may be controlled to move from a first position associated with the plurality of groups 116 to a second position associated with the set of cohorts 120 at the interruption time. In an embodiment, the set of actuators 118 may be controlled to render at least one of media content, a recommendation, audio content, background noises or an interactive chat to the set of users 108 at the interruption time. In another embodiment, the set of actuators 118 may be controlled to determine the schedule for an activity associated with the set of users 108 at the location, based on the set of cohorts 120 at the interruption time. The transformation of the disposition of the set of users 108 from the plurality of groups 116 to the set of cohorts 120 may increase an interactivity level of the set of users 108 based on a re-arrangement of the set of users 108 according to common interests of such users.

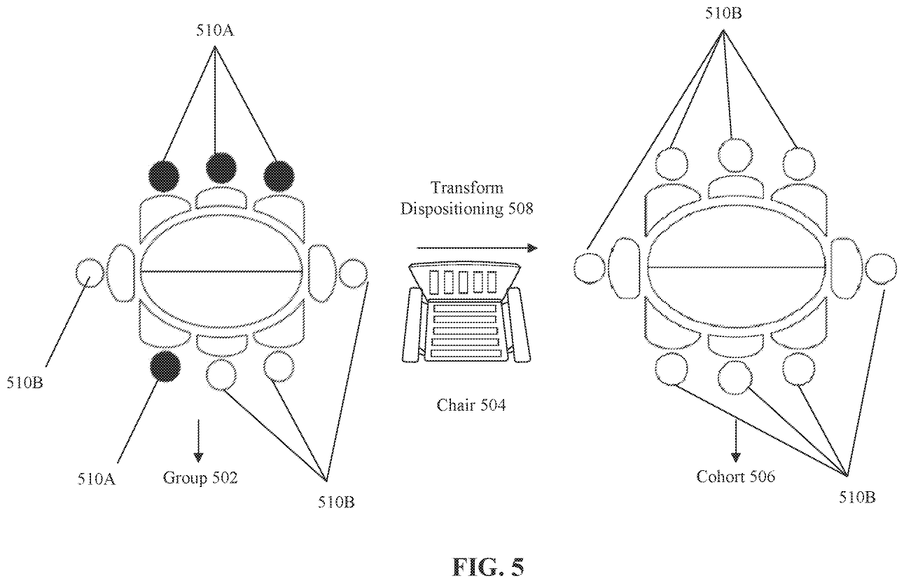

FIG. 5 is a diagram that illustrates an exemplary scenario for transformation of dispositioning of the set of users from the plurality of groups to the set of cohorts, in accordance with an embodiment of the disclosure. FIG. 5 is described in conjunction with elements from FIG. 1, FIG. 2, FIG. 3, and FIG. 4. With reference to FIG. 5, there is shown an exemplary scenario 500. The scenario 500 may include a set of users including users 510A and users 510B. The scenario 500 may further include a chair 504 (belonging to the set of actuators 118), a group 502, and a cohort 506. The scenario 500 further illustrates an exemplary (transformation of) dispositioning 508 of the users 510B associated with the scenario 500 is described herein.

In the scenario 500 of FIG. 5, the group 502 may include the users 510A and the users 510B seated together. In an example, the users 510A may belong to a cohort and the users 510B may belong to another cohort. The electronic device 102 may be configured to control the chair 504 for transformation of the dispositioning 508 of the users 510B from the group 502 to the cohort 506. Further, the chair 504 may be configured to move from a first position associated with the group 502 to a second position associated with the cohort 506. Further, it may be noted that the users 510A may be dispositioned to another cohort from the group 502 by another chair (associated with the set of actuators 118). It should be noted that scenario 500 of FIG. 5 is for exemplary purposes and should not be construed to limit the scope of the disclosure.

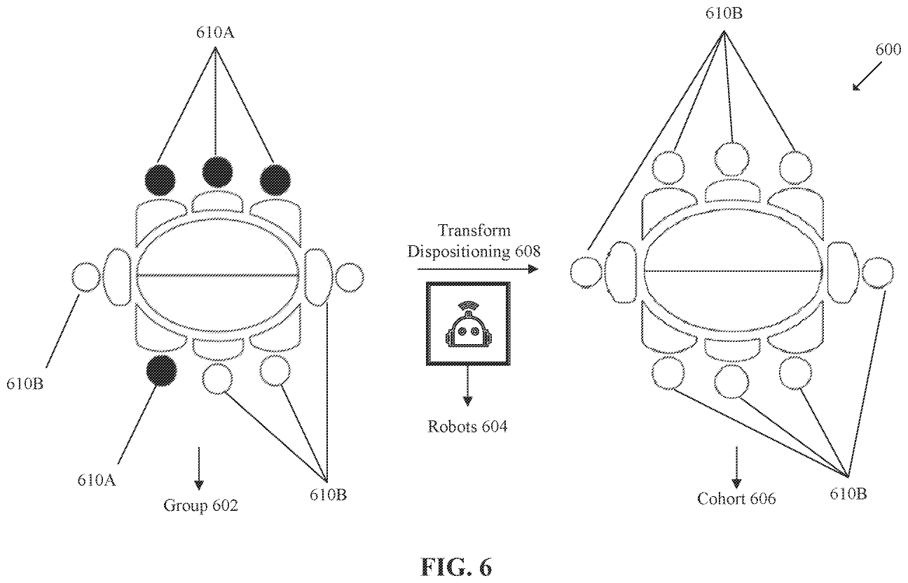

FIG. 6 is a diagram that illustrates an exemplary scenario for transformation of dispositioning of the set of users from the plurality of groups to the set of cohorts, in accordance with an embodiment of the disclosure. FIG. 6 is described in conjunction with elements from FIG. 1, FIG. 2, FIG. 3, FIG. 4 and FIG. 5. With reference to FIG. 6, there is shown an exemplary scenario 600. The scenario 600 may include a set of users including users 610A and users 610B. The scenario 600 may further include robots 604 (belonging to the set of actuators 118), a group 602 and a cohort 606. The scenario 600 further illustrates an exemplary (transformation of) dispositioning 608 of the users 610B associated with the scenario 600 is described herein.

In the scenario 600 of FIG. 6, the group 602 includes the users 610A and the users 610B seated together. In an example, the users 610A may belong to a cohort and the users 610B may belong to another cohort. The electronic device 102 may be configured to control the robots 604 for transformation of the dispositioning 608 of the users 610B from the group 602 to the cohort 606. Further, the robot 604 may be configured to render at least one of media content, a recommendation, or an interactive chat to the users 610A and the users 610B. Further, it may be noted that the users 610A may be dispositioned to another cohort from the group 602 by the robot 604 (associated with the set of actuators 118). Furthermore, it may be noted that the control of the robot 604 may be configured to transform the dispositioning 608 of the users 610B from the group 602 to the cohort 606. It should be noted that scenario 600 of FIG. 6 is for exemplary purposes and should not be construed to limit the scope of the disclosure.

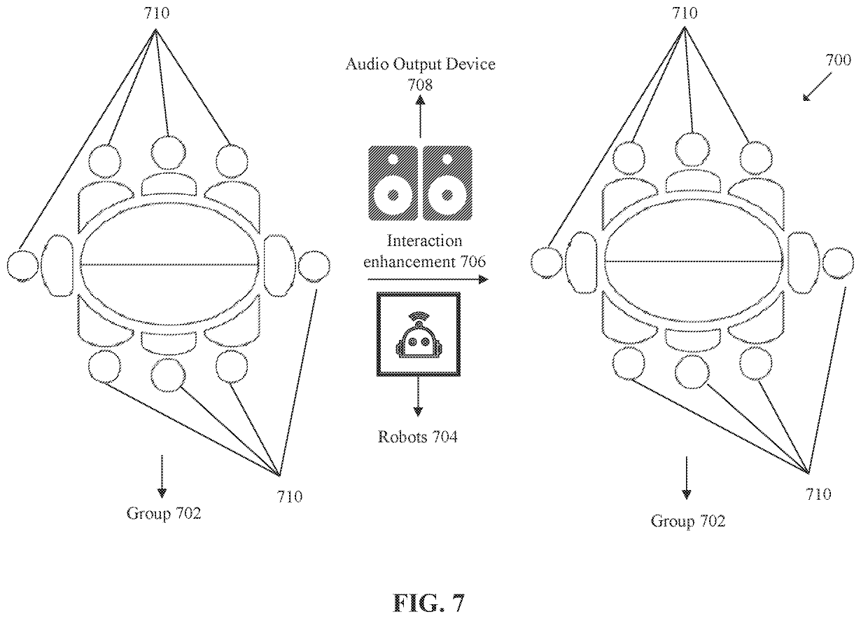

FIG. 7 is a diagram that illustrates an exemplary scenario for enhancement of interaction between users in a group or cohort, in accordance with an embodiment of the disclosure. FIG. 7 is described in conjunction with elements from FIG. 1, FIG. 2, FIG. 3, FIG. 4, FIG. 5, and FIG. 6. With reference to FIG. 7, there is shown an exemplary scenario 700. The scenario 700 may include a set of users 710. The scenario 700 may further include robot 704 (associated with set of actuators 118), an audio-output device 708 (associated with set of actuators 118), and a group 702. The scenario 700 further illustrates an exemplary interaction enhancement 706 of the set of users 710 associated with the scenario 700 is described herein.

In the scenario 700 of FIG. 7, the group 702 includes the set of users 710, where the set of users 710 may belong to a cohort. Further, it may be noted that even if the set of users 710 may belong to a cohort, in certain scenarios, an interactivity level of the set of users 710 may be low. Thus, the electronic device 102 may be configured to control the robot 704 and the audio-output device 708 for enhancing the interactivity between the set of users 710 associated from the group 702 that may also be cohorts. Further, the robots 704 may be configured to render at least one of media content, a recommendation, or an interactive chat to the set of users 710 and the audio-output device 708 may be configured to render at least one of audio content or background noises to the set of users 710. It should be noted that scenario 700 of FIG. 7 is for exemplary purposes and should not be construed to limit the scope of the disclosure.

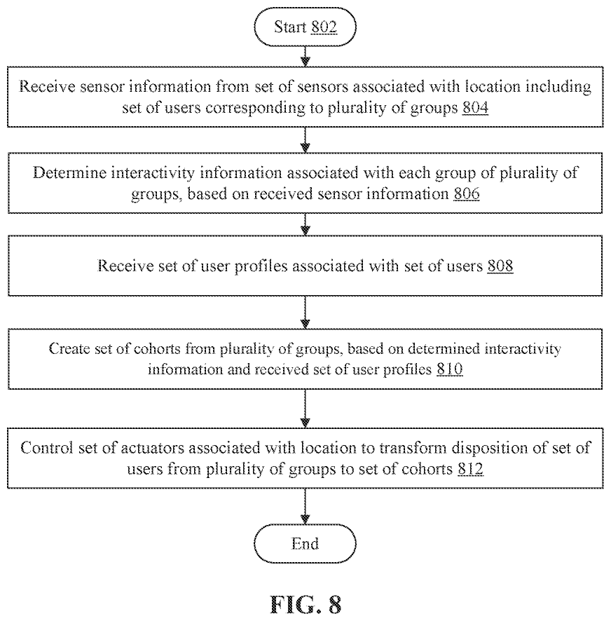

FIG. 8 is a flowchart that illustrates operations of an exemplary method for user cohort creation based on interactivity and profile of users, in accordance with an embodiment of the disclosure. FIG. 8 is described in conjunction with elements from FIG. 1, FIG. 2, FIG. 3, FIG. 4, FIG. 5, FIG. 6, and FIG. 7. With reference to FIG. 8, there is shown a flowchart 800. The flowchart 800 may include operations from 802 to 812 and may be implemented by the electronic device 102 of FIG. 1. The flowchart 800 may start at 802 and proceed to 804.

At 804, the sensor information may be received from the set of sensors 104 associated with the location 122 including the set of users 108 corresponding to the plurality of groups 116 may be received. The plurality of groups 116 are hereinafter interchangeably referred as a set of groups 116. The processor 308 may be configured to receive the sensor information from the set of sensors. Details related to the sensor information are further described, for example, in FIG. 4 (at 402).

At 806, the interactivity information associated with each group of the plurality of groups 116 may be determined based on the received sensor information. The processor 308 may be configured to determine the interactivity information associated with each group of the plurality of groups 116. Details related to the determination of the interactivity information are further described, for example, in FIG. 4 (at 404).

At 808, the set of user profiles 114 associated with the set of users 108 may be received. The processor 308 may be configured to receive the set of user profiles 114. Details related to the reception of the set of user profiles are further described, for example, in FIG. 4 (at 406).

At 810, the set of cohorts 120 may be created from the plurality of groups 116. The processor 308 may be configured to create the set of cohorts 120 from the plurality of groups 116, based on the determined interactivity information and the received set of user profiles 114. Details related to the creation of the set of cohorts are further described, for example, in FIG. 4 (at 408).

At 812, the set of actuators 118 associated with the location 122 may be controlled. The processor 308 may be configured to control the set of actuators 118 associated with the location 122 to transform a disposition of the set of users 108 from the plurality of groups to the set of cohorts. Details related to the controlling of the set of actuators are further described, for example, in FIG. 4 (at 410 to 414). Control may pass to end.

Although the flowchart 800 is illustrated as discrete operations, such as 804, 806, 808, 810, and 812 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include reception of sensor information from a set of sensors (e.g., the set of sensors 104) associated with a location (such as the location 122) including a set of users (such as the set of users 108 of FIG. 1) corresponding to the plurality of groups (such as the plurality of groups 116 of FIG. 1). The operations may further include detection of interactivity information associated with each group of the plurality of groups, based on the received sensor information. The operations may further include reception of a set of user profiles (e.g., the set of user profiles 114) associated with the set of users 108. The operations may further include creation of a set of cohorts (e.g., the set of cohorts 120) from the plurality of groups 116, based on the determined interactivity information and the received set of user profiles 114. The operations may further include controlling a set of actuators (e.g., the set of actuators 118) associated with the location 122 to transform the disposition of the set of users 108 from the plurality of groups 116 to the set of cohorts 120.

Exemplary aspects of the disclosure may provide an electronic device (such as the electronic device 102 of FIG. 1) that includes circuitry (such as the processor 308). The processor 308 may be configured to receive the sensor information from the set of sensors 104 associated with the location 122 including the set of users 108 corresponding to the plurality of groups 116. The processor 308 may be configured to determine interactivity information associated with each group of the plurality groups, based on the received sensor information. The processor 308 may be configured to receive the set of user profiles 114 associated with the set of users 108. The processor 308 may be configured to create the set of cohorts 120 from the plurality of groups 116, based on the determined interactivity information and the received set of user profiles 114. The processor 308 may be configured to control the set of actuators 118 associated with the location 122 to transform the disposition of the set of users 108 from the plurality of groups 116 to the set of cohorts 120.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. An electronic device, comprising:
circuitry configured to:
receive sensor information from a set of sensors associated with a location including a set of users corresponding to a plurality of groups;
determine interactivity information associated with each group of the plurality of groups, based on the received sensor information;
receive a set of user profiles associated with the set of users;
create a set of cohorts from the plurality of groups, based on the determined interactivity information and the received set of user profiles; and
control a set of actuators associated with the location to transform a disposition of the set of users from the plurality of groups to the set of cohorts.

2. The electronic device according to claim 1, wherein the set of sensors includes at least one of: an infrared sensor, a radio frequency sensor, a proximity sensor, a photoelectric sensor, a touch sensor, a photodetector, a camera, an audio-input device, a pressure sensor, a thermistor, a position sensor, a temperature sensor, a humidity sensor, a strain sensor, or a weight sensors.

3. The electronic device according to claim 1, wherein the set of sensors is associated to the set of actuators, and the set of actuators correspond to at least one of: a chair, a table, a robot, an audio-output device, or a scheduler associated with the location.

4. The electronic device according to claim 3, the circuitry is further configured to:
control the chair to transform the disposition of the set of users from the plurality of groups to the set of cohorts, wherein the control of the chair is configured to move the chair from a first position associated with the plurality of groups to a second position associated with the set of cohorts.

5. The electronic device according to claim 3, the circuitry is further configured to:
control the table to transform the disposition of the set of users from the plurality of groups to the set of cohorts, wherein the control of the table is configured to move the table from a first position associated with the plurality of groups to a second position associated with the set of cohorts.

6. The electronic device according to claim 3, the circuitry is further configured to:
control the robot to render at least one of media content, a recommendation, or an interactive chat to the set of users, wherein the control of the robot is configured to transform the disposition of the set of users from the plurality of groups to the set of cohorts.

7. The electronic device according to claim 3, the circuitry is further configured to:
control the audio-output device to render at least one of audio content or background noises to the set of users, wherein the control of the audio-output device is configured to transform the disposition of the set of users from the plurality of groups to the set of cohorts.

8. The electronic device according to claim 3, the circuitry is further configured to:
control the scheduler to determine a schedule for an activity associated with the set of users at the location, based on the set of cohorts, wherein the activity corresponds to at least one of: a serving of a course of a meal, a speech, or a game.

9. The electronic device according to claim 1, wherein the received sensor information corresponds to at least one of: a gesture, a posture, a speech, a gaze, an action, or a facial orientation, associated with the set of users.

10. The electronic device according to claim 1, wherein the circuitry is further configured to:
apply a machine learning (ML) model on the received sensor information, wherein the determination of the interactivity information is further based on the application of the ML model.

11. The electronic device according to claim 1, wherein each user profile of the set of user profiles includes at least one of: an area of interest of a user, demographic information of the user, beliefs of the user, aversions of the user, or skills of the user.

12. The electronic device according to claim 1, wherein the circuitry is further configured to:
determine a time for interruption of an ongoing conversation between users of a group of the plurality of groups, wherein the determination of the time for interruption is based on the received sensor information; and
control the set of actuators to interrupt the ongoing conversation between the users of the group at the determined time.

13. A method, comprising:
in an electronic device:
receiving sensor information from a set of sensors associated with a location including a set of users corresponding to a plurality of groups;
determining interactivity information associated with each group of the plurality of groups, based on the received sensor information;
receiving a set of user profiles associated with the set of users;
creating a set of cohorts from the plurality of groups, based on the determined interactivity information and the received set of user profiles; and
controlling a set of actuators associated with the location to transform a disposition of the set of users from the plurality of groups to the set of cohorts.

14. The method according to claim 13, wherein the set of sensors is associated to the set of actuators, and the set of actuators correspond to at least one of: a chair, a table, a robot, an audio-output device, or a scheduler, associated with the location.

15. The method according to claim 14, further comprising:
controlling the chair to transform the disposition of the set of users from the plurality of groups to the set of cohorts, wherein the control of the chair is configured to move the chair from a first position associated with the plurality of groups to a second position associated with the set of cohorts.

16. The method according to claim 14, further comprising:
controlling the table to transform the disposition of the set of users from the plurality of groups to the set of cohorts, wherein the control of the table is configured to move the table from a first position associated with the plurality of groups to a second position associated with the set of cohorts.

17. The method according to claim 14, further comprising:
controlling the robot to render at least one of media content, a recommendation, or an interactive chat to the set of users, wherein the control of the robot is configured to transform the disposition of the set of users from the plurality of groups to the set of cohorts.

18. The method according to claim 14, further comprising:
controlling the audio-output device to render at least one of audio content or background noises to the set of users, wherein the control of the audio-output device is configured to transform the disposition of the set of users from the plurality of groups to the set of cohorts.

19. The method according to claim 14, further comprising:
controlling the scheduler to determine a schedule for an activity associated with the set of users at the location, based on the set of cohorts, wherein the activity corresponds to at least one of: a serving of a course of a meal, a speech, or a game.

20. A non-transitory computer-readable medium having stored thereon, computer-executable instructions that when executed by an electronic device, causes the electronic device to execute operations, the operations comprising:
receiving sensor information from a set of sensors associated with a location including a set of users corresponding to a plurality of groups;
determining interactivity information associated with each group of the plurality of groups, based on the received sensor information;
receiving a set of user profiles associated with the set of users;
creating a set of cohorts from the plurality of groups, based on the determined interactivity information and the received set of user profiles; and
controlling a set of actuators associated with the location to transform a disposition of the set of users from the plurality of groups to the set of cohorts.
